(19) United States
(12) Patent Application Publication
(10) Pub. No.: US 2003/0027625 A1
(43) Pub. Date: Feb. 6, 2003

(54) Multiple progressive and bonusing table game methods and apparatus

(75) Inventor: Richard E. Rowe, Reno, NV (US)

Correspondence Address: BEYER WEAVER & THOMAS LLP, P.O. BOX 778, BERKELEY, CA, 94704-0778, US

(73) Assignee: International Game Technology

(21) Appl. No.: 09/927,181

(22) Filed: Aug. 6, 2001

(51) Int. Cl. A63F 13/00

(52) U.S. Cl. 463/20; 463/25

(57) ABSTRACT

A progressive gaming system is described having multiple progressive games associated with a plurality of table games. The system includes a plurality of network nodes, each of which is associated with one of the plurality of table games and is operable to transmit first information relating to game activity corresponding to the associated table game. A network interconnects the plurality of network nodes. A server is connected to the network for managing the plurality of progressive games. The server is operable to use the first information from the network nodes to control a plurality of awards associated with the plurality of progressive games. The server is also operable to assign at least one of the awards to a player at a corresponding one of the table games in response to a corresponding event.

### BACKGROUND OF THE INVENTION

The present invention relates to progressive games provided in, for example, a gaming establishment such as a casino. More specifically, the present invention provides methods and apparatus for managing such progressive games for one or more table games or combinations of table games and gaming machines.

For quite some time, gaming establishments have offered progressive games in which multiple gaming machines, e.g., slot machines or gaming terminals, are connected and the respective players of the connected gaming machines compete against each other for a progressive jackpot which grows progressively larger over time (hence the name). Such progressive jackpots typically grow in relation to the rate of play across all of the participating machines as determined, for example, by the cumulative amount of money taken in by those machines. Payment of the progressive jackpot to a player of one of the participating gaming machines is typically triggered by an event such as, for example, a win by the player on his gaming machine, or even a specific card or reel combination. Progressive games are generally seen as being a very effective way of increasing player interest and enthusiasm as well as enhancing the player's overall gaming experience.

As gaming systems have become more sophisticated and have taken advantage of advances in computer and networking technologies, the sophistication of progressive gaming has similarly increased. For example, gaming systems have been deployed in which multiple progressive games are simultaneously and centrally managed, each progressive corresponding to a subset of a large number of gaming machines interconnected by a gaming network and managed by one or more servers on the network. Such a system is described, for example, in U.S. Pat. No. 5,885,158 for GAMING SYSTEM FOR MULTIPLE PROGRESSIVE GAMES issued on Mar. 23, 1999, the entire disclosure of which is incorporated herein by reference. Such centrally managed progressive systems allow gaming establishments to make progressive gaming available to a greater number of players, provide for economies of scale, and in general provide for greater flexibility in establishing and maintaining progressive games.

By contrast, and largely due to the way in which such games have traditionally operated, progressive games in the table game environment have not enjoyed the same levels of popularity and success as their gaming machine counterparts. That is, partly due to the fact that table games are not as amenable to incorporation of the latest technology, and partly due to the traditional separation of slots and tables, table game progressives have not been able to leverage technology in the same way as the progressives associated with gaming machines.

In a conventional table game progressive (which is usually unique to a specific table and always managed independently), a player typically must actively participate by making certain types of special qualifying wagers in addition to playing the table game itself. The awarding of a progressive jackpot in the table game setting is also typically triggered by the occurrence of an event specifically related to the table game, e.g., the occurrence of a certain combination of cards.

In addition, much of the tracking of player participation in a table game progressive as well as the determination as to when to award a progressive jackpot is done manually by the dealer and/or the pit boss. For example, the dealer might make visual estimates of the wagers of participating players and enter those numbers into the system where they are then used to augment the current jackpot. The dealer, having foreknowledge of the winning combination(s) would then visually identify when such a combination occurs, thereby identifying the winner of the progressive jackpot. This makes it difficult to manage a single table game progressive, much less multiple progressives associated with multiple table games and/or gaming machines.

In view of the foregoing, it is desirable to provide techniques by which advances in gaming, computer, and networking technology can be leveraged in the table gaming environment to provide better ways of managing progressive games, and to therefore increase the benefits of table game progressives for both the player and the gaming establishment.

### SUMMARY OF THE INVENTION

According to the present invention, the benefits of progressive gaming in the table game context are more fully realized. According to a specific embodiment of the present invention, multiple progressive games associated with multiple table games are centrally managed. According to another embodiment, a single progressive relating to a combination of table games and gaming machines is provided. According to yet another embodiment, multiple progressives associated with a combination of table games and gaming machines are centrally managed.

According to another specific embodiment of the present invention, multiple progressive jackpots are accumulated based on activity at multiple table games, multiple gaming machines, or combinations thereof. The awarding of any one of the progressive jackpots to a randomly selected player at any of those tables or machines is triggered by the occurrence of a random event which is unrelated to the wagering activity by the selected player.

According to a more specific embodiment, multiple progressives relating to a combination of tables and machines are centrally managed, the payout of one progressive being triggered by occurrence of a random event which, in various embodiments, relates to one or more of the other progressives. For example, the winning of a first progressive jackpot by a player on a gaming machine could be the event which triggers the awarding of a second progressive jackpot to a randomly selected player at a black jack table.

According to various embodiments, the tables and machine involved in the single or multiple progressive systems of the present invention may be at a single gaming venue or multiple gaming venues.

According to various embodiments of the invention, the award associated with a progressive does not have to be money. That is, the winning player may be awarded bonus points on his player tracking card, or any of a variety of prizes or complimentary services. All of these various types of progressive “jackpots” are centrally managed. Similarly, the triggering event does not need to be an event related to any of the current progressive games or play at any of the tables or machines. Rather, the event could be any event such as being the 100^{th} player to use a particular gaming machine, or relate to user-specific information, e.g., the player's birthday as determined from the player tracking system.

Thus, the present invention provides a progressive gaming system having multiple progressive games associated with a plurality of table games. The system includes a plurality of network nodes, each of which is associated with one of the plurality of table games and is operable to transmit first information relating to game activity corresponding to the associated table game. A network interconnects the plurality of network nodes. A server is connected to the network for managing the plurality of progressive games. The server is operable to use the first information from the network nodes to control a plurality of awards associated with the plurality of progressive games. The server is also operable to assign at least one of the awards to a player at a corresponding one of the table games in response to a corresponding event.

According to another embodiment, a progressive gaming system is provided having a plurality of table games and a plurality of network nodes. Each network node is associated with one of the plurality of table games and is operable to transmit first information relating to game activity corresponding to the associated table game. The system also includes a plurality of gaming machines, each being operable to transmit second information relating to game activity corresponding thereto. A network interconnects the plurality of network nodes and the plurality of gaming machines. A server connected to the network manages at least one progressive game associated with the plurality of table games and the plurality of gaming machines. The server is operable to use the first information from the network nodes and the second information from the gaming machines to control at least one award associated with the at least one progressive game. The server is also operable to assign the at least one award to a player at a corresponding one of the table games and the gaming machines in response to an event.

According to yet another embodiment, a progressive gaming system is provided having a plurality of network gaming nodes having at least one progressive game associated therewith. Each network node is operable to transmit information relating to associated game activity. A network interconnects the plurality of network gaming nodes. A server connected to the network manages the at least one progressive game, the server being operable to use the information from the network gaming nodes to control at least one award associated with the at least one progressive game. The server is also operable to assign the at least one award to a player associated with a first one of the network gaming nodes in response to an event unrelated to the game activity associated with the first one of the network gaming nodes.

A further understanding of the nature and advantages of the present invention may be realized by reference to the remaining portions of the specification and the drawings.

### BRIEF DESCRIPTION OF THE DRAWINGS

FIG. 1 is a block diagram of a gaming network in which various embodiments of the present invention may be implemented;

FIG. 2 is a block diagram of a table game network node for use with various embodiments of the present invention;

FIG. 3 is a block diagram of a gaming machine for use with embodiments of the present invention; and

FIG. 4 is a flowchart illustrating a specific embodiment of the present invention in which multiple table game progressives are centrally managed.

### DETAILED DESCRIPTION OF SPECIFIC EMBODIMENTS

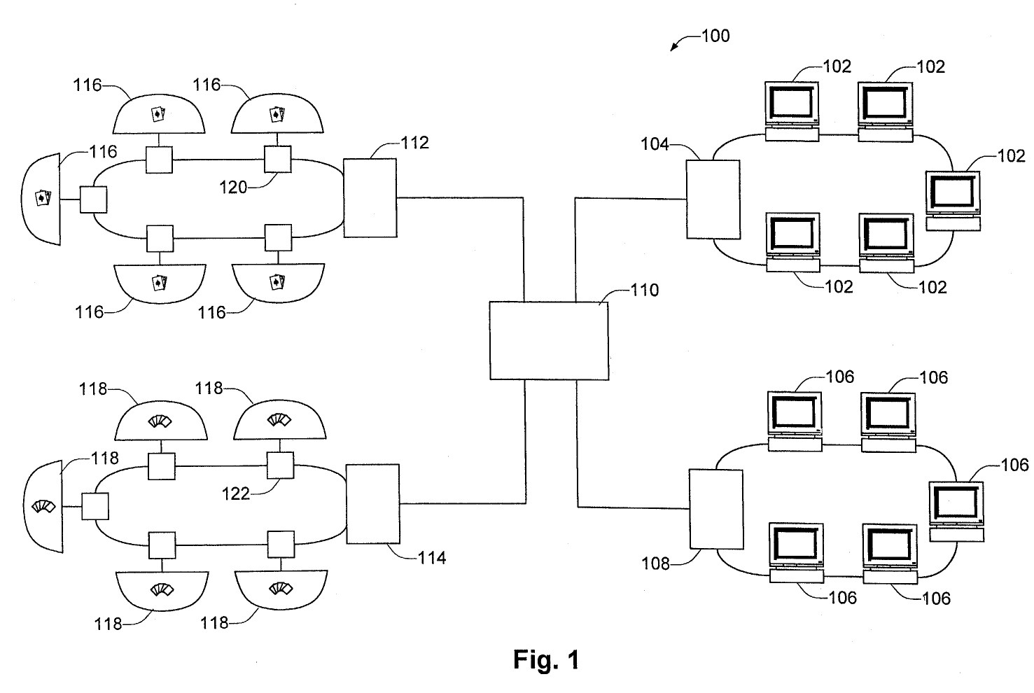

FIG. 1 is a simplified block diagram of a gaming network 100 in which various embodiments of the present invention may be implemented. A first group of gaming machines 102 are connected to network 100 via intermediate terminal 104. A second group of gaming machines 106 are connected to network 100 via intermediate terminal 108. Gaming machines 102 and 106 may comprise any of a variety of gaming terminals or machines such as, for example, electromechanical slot machines and video slot and poker terminals.

Intermediate terminals 104 and 108 may have varying levels of functionality. That is, terminals 104 and 108 may simply facilitate interaction between their respective gaming machines and central server 110. Alternatively, terminals 104 and 108 may be used to effect a variety of functionalities related to the associated gaming machines such as player tracking function. Such terminals may also allow authorized personnel to control selected ones of the associated gaming machines, and even facilitate gaming on the associated machines using distributed computing techniques.

Server 110 is also connected via network 100 and intermediate terminals 112 and 114 to a plurality of table games 116 and 118, each of which has an associated interface (nodes 120 and 122) which may be network nodes with processing capabilities, or may simply be interface circuitry connecting table games 116 and 118 to intermediate terminals 112 and 114, respectively. Table games 116 and 118 may be any of a variety of table or pit games such as, for example, black jack, various types of poker, roulette, craps, and any other table game where wagering is allowed (e.g., Let It Ride, Pi Go Poker, War, etc). And as described above with reference to terminals 104 and 108, intermediate terminals 112 and 114 may have various levels of functionality according to different embodiments of the invention.

It should be understood that gaming network 100 is merely one exemplary environment in which embodiments of the present invention may be practiced. For example, server 110 may represent a single server interconnecting a plurality of nodes on a local area network, or one or more servers interconnecting the various nodes via a wide area network which may correspond to one gaming venue or multiple gaming venues, and may further include portions of the Internet or World Wide Web.

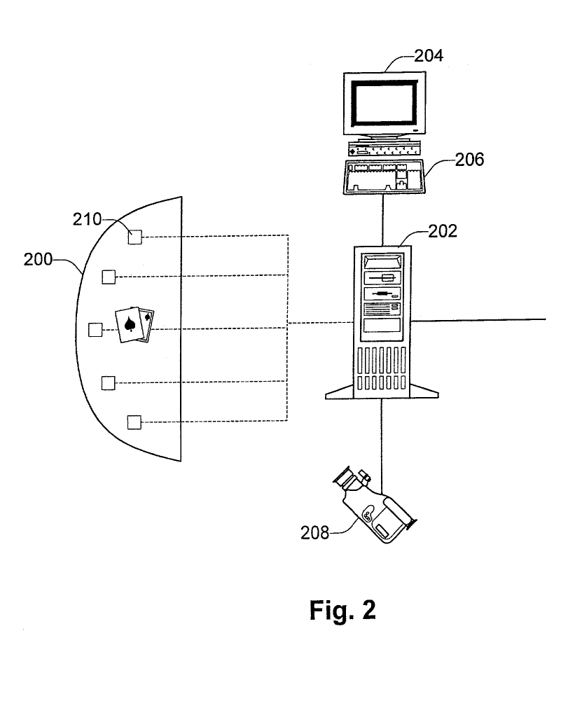

FIG. 2 is a block diagram of an exemplary table game 200 and associated network gaming node 202 for use with various embodiments of the present invention. For example, table game 200 and network node 202 may be used to implement any of the table games and associated network nodes of FIG. 1. As described above, table game 200 may be set up for any of a wide variety of pit games such as, for example, black jack, poker, craps, etc.

According to various embodiments, network node 202 comprises a personal computer, workstation, or the equivalent, and may communicate with a network (e.g., network 100 of FIG. 1) using any of a variety of proprietary or conventional networking protocols, e.g., Ethernet or TCP/IP. Network node 202 is accompanied by a display monitor 204 and a keyboard 206.

Information about the game activity occurring on table game 200 may be provided to network node 202 in any of a wide variety of ways. For example, a digital video camera 208 may be used to monitor table activity, providing digital video data to network node 202 which may then be displayed on monitor 204 or any other node on the network. These video data may be used for security purposes, but also to automatically and/or manually monitor game activity for the purpose of controlling the accumulation of a progressive jackpot with which the table is associated.

Game activity at table game 200 may also be tabulated for any associated progressive game by the manual inputting of information (e.g., using keyboard 206) derived from observations by the dealer or pit boss, either direct or via monitor 204. According to some embodiments sensors 210 are associated with table game 202 either in the table itself or in seats associated with the table to provide additional game activity information to network node 202 for use in controlling of the jackpots for any associated progressive games. Such sensors could, for example, indicate when players are seated at the table. According to one embodiment, sensors in the table at each player's location are operable to determine the number and denominations of chips placed in the wagering areas of the table, thereby enabling the tracking of the amounts wagered by each player. This could be accomplished using any of a wide variety of sensing technologies including, for example, bar coding, wireless tags (e.g., RF or infrared), electromagnetic sensing, spectroscopy, etc.

According to various embodiments, each table game 200 in a gaming network might have an associated network node 202 as shown in FIG. 1. Alternatively, several table games in a pit might be associated with one network node. In any case, the information relating to the game activity at table game 200 is received by the associated network node and transmitted over the associated network for any of a variety of uses including, for example, effecting control or triggering payment of a progressive jackpot.

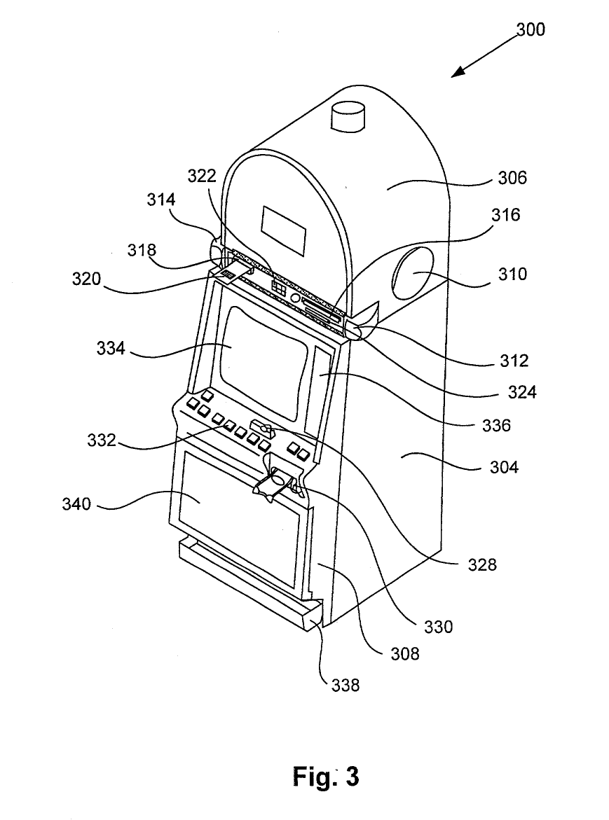

FIG. 3 is a block diagram of an exemplary video gaming machine 300 for use with various embodiments of the present invention. For example, gaming machine 300 may be used to implement any of the gaming machines of FIG. 1. Gaming machine 300 can correspond to many possible games including, for example, traditional slot games, video slot games, video poker, and video keno.

Machine 300 includes a main cabinet 304, which generally surrounds the machine interior (not shown) and is viewable by users. The main cabinet includes a main door 308 on the front of the machine, which opens to provide access to the interior of the machine. Attached to the main door are player-input switches or buttons 332, a coin acceptor 328, and a bill validator 330, a coin tray 338, and a belly glass 340. Viewable through the main door is a video display monitor 334 and an information panel 336. The display monitor 334 will typically be a cathode ray tube, high resolution flat-panel LCD, or other conventional electronically controlled video monitor. The information panel 336 may be a back-lit, silk screened glass panel with lettering to indicate general game information including, for example, the number of coins played. The bill validator 330, player-input switches 332, video display monitor 334, and information panel are devices used to play a game on the game machine 300.

The various device and functionalities of gaming machine 300 devices are controlled by circuitry (not shown) housed inside the main cabinet 304. According to some embodiments, the control circuitry of gaming machine 300 comprises a conventional personal computer, workstation, or similar device which facilitates the functionality of the individual gaming machine 300 as well as provides an interface (not shown) to a gaming network (e.g., gaming network 100 of FIG. 1) using proprietary or conventional protocols such as, for example, Ethernet, TCP/IP, etc. Using such an interface, information relating to game activity on gaming machine 300 may be transmitted over the gaming network for any of a variety of purposes including, for example, effecting control or triggering payment of a progressive jackpot.

The gaming machine 300 includes a top box 306, which sits on top of the main cabinet 304. The top box 306 houses a number of devices, which may be used to add features to a game being played on the gaming machine 300, including speakers 310, 312, 314, a ticket printer 318 which may print bar-coded tickets 320, a key pad 322 for entering player tracking information, a florescent display 316 for displaying player tracking information, a card reader 324 for entering a magnetic striped card containing player tracking information. Further, the top box 306 may house different or additional devices than shown in FIG. 3. For example, the top box may contain a bonus wheel or a back-lit silk screened panel which may be used to add bonus features to the game being played on the gaming machine. During a game, these devices are controlled and powered, in part, by circuitry (not shown) housed within the main cabinet 304 of the machine 300.

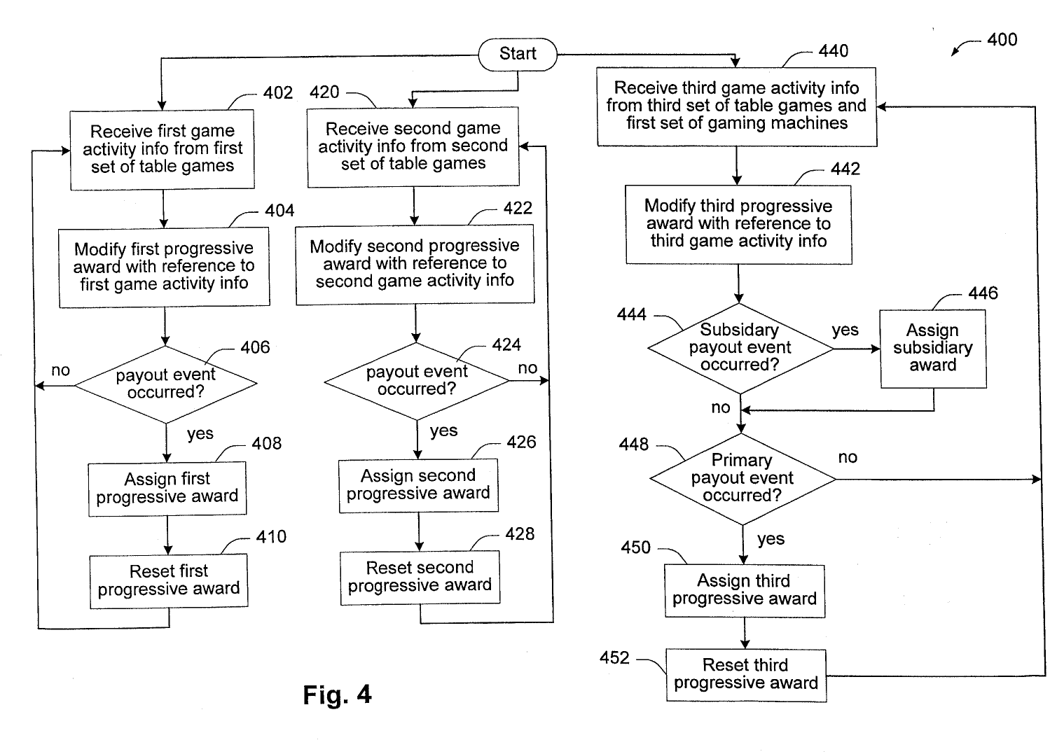

FIG. 4 is a flowchart illustrating a specific embodiment of the present invention in which multiple progressive games are simultaneously managed. Each progressive is represented as an independent thread, although it will be understood that the progressives may be interrelated such as, for example, where the occurrence of an event in one progressive triggers the payment of a jackpot or award associated with another progressive.

It should also be noted that the present invention is not limited to systems in which all of the progressive threads shown are included. Rather, different subsets of the threads shown as well as various subsets of the thread components represent different specific embodiments of the invention. For example, the scope of the present invention encompasses systems in which two or more table-game-only progressives are centrally managed. In addition, the scope of the invention also includes one or more progressives which involves a combination of table games and gaming machines. Moreover, a portion of a particular thread relating, for example, to the “random” assignment of a primary or subsidiary progressive award may correspond to yet another embodiment.

Referring now to FIG. 4, three centrally managed progressive games are shown. In a first progressive game which is related exclusively to table games, game activity from the associated table games is received by the server managing the progressives (402). As discussed above, this information may take a variety of forms and relates generally to wagering and participation activity engaged in by individuals at the associated table games. The information may also include information specific to individual players, e.g., player tracking information, which may include personal identification information and historical gaming data. This information is used in any of a variety of manners, at least some of which are well known, to augment, modify, or otherwise control a first progressive jackpot or award associated with the first progressive (404). It should be noted that any technique by which game activity information is used to control an associated progressive award is within the scope of the invention. The receiving of the game activity information and the modification of the corresponding jackpot continues until a specified payout event occurs (406).

If the specified payout event occurs (406), the first progressive award is assigned to a player (408) and is reset (410). According to various embodiments of the invention, both the nature of the payout event and the manner in which the progressive award is assigned may vary greatly. That is, the payout event may be any of the traditional events triggering a progressive payout, e.g., a particular card combination by a player who is affirmatively and knowingly participating in the progressive. Alternatively, the event may correspond to some behavior or action by a player who may be unaware of his participation.

According to some embodiments, the progressive award may be assigned to the player whose activity precipitated the payout, e.g., the player who was dealt a particular card combination. Alternatively, the event which triggered the payout and the player to whom the payout is assigned may be unrelated. For example, the assignment of a progressive jackpot to player 1 might be precipitated by the occurrence of a card combination dealt to any other player at any of the tables associated with the progressive, i.e., a “random” assignment.

According to various embodiments, examples of payout events may include insertion or extraction of a player tracking card in a gaming machine or work station associated with a table game, the winning of the top award associated with a group of gaming machines, a player receiving a specific combination corresponding to a specific pay line entry on a gaming machine, the passage of a period of time, the accumulation of a certain number of player tracking points by a player, etc. As will be understood with reference to the disparate nature of these examples, the payout event could be just about anything.

A second progressive game relating exclusively to table games and corresponding to 420-428 is managed simultaneously with the first progressive game, and in much the same way as described above with reference to 402-410. That is, game activity information from a second set of table games is received (420) and used to modify a second progressive award (422) which, in response to the occurrence of a corresponding payout event (424), is assigned (426) and reset (428). The nature of the payout event and the manner in which the second progressive award is assigned may also vary greatly as described above.

A third thread representing a third progressive game relating to a combination of table games and gaming machines is also shown in FIG. 4. Game activity information from both the associated table games and the associated gaming machines is received by the server managing the progressives (440). The game activity information for the table games may be acquired as described above. As with the information generated at the table games, the game activity information generated by the gaming machines may take a variety of forms and relates generally to wagering and other related activity engaged in by individuals at the associated machines, and may include user-specific player tracking data.

A third progressive award or jackpot is augmented, modified, or otherwise controlled using the game activity information received from the combination of table games and gaming machines (442). As will be understood, the manner in which the progressive award is modified using this information may vary widely and still remain within the scope of the invention. For example, the award may increase in accordance with some proportion of the total amount wagered at all of the associated tables and machines. Alternatively, the award may increase with time in accordance with the number of players at the associated tables and games. Any technique by which game activity information from both table games and gaming machines is used to control an associated progressive award is within the scope of the invention.

Unlike the first and second progressives described above, the third progressive has at least one additional subsidiary award associated therewith. According to various embodiments of the present invention, a subsidiary award may comprises any of a wide variety of awards which are typically more modest than the primary progressive award derived from the game activity information. For example, a subsidiary award might be a small monetary credit, e.g., $5 or $10, for use in one or more gaming machines, a complimentary meal or room night at the gaming establishment, merchandise, etc. Such awards can even be more substantial items such as, for example, an automobile or a vacation getaway. One or more such subsidiary awards may be associated with any of the progressives being managed by the system.

If a subsidiary payout event occurs (444) a corresponding subsidiary award is assigned (446). The nature of an event which may trigger the assignment of a subsidiary award may vary rather dramatically. In addition, and according to some embodiments, the magnitude of the award is somewhat correlated with the nature of the event. For example, if it is the birthday of a particular player at a table or machine associated with the progressive (as determined, for example, from a player tracking system), a subsidiary award of a complimentary meal at the establishment's restaurant or a gaming credit might be automatically awarded to that player. In fact, any user-specific information derived from such a player tracking system (e.g., anniversaries, number of visits, time since last visit, wagering activity, etc.) may be used to trigger the assignment of a subsidiary award. Other types of events unrelated to a specific user's personal information or gaming history may also be used to trigger the assignment of a subsidiary award. For example, the assignment of the primary progressive jackpot with which the subsidiary award is associated may trigger the assignment of the subsidiary award.

The manner in which a subsidiary award is assigned may also vary. For example, the award may be assigned to the individual with whom the event is associated, e.g., the player having a birthday or an anniversary. Alternatively, the award may be randomly assigned to any of the players at any of the tables or machines associated with the progressive, e.g., if a progressive jackpot over a certain amount is won by a first player, one or more other players might be awarded a complimentary rooms for the evening.

The assignment of the primary progressive award for the this third progressive occurs in a manner similar to that described above for the first and second progressive threads. That is, upon the occurrence of a primary payout event (448), the third progressive award is assigned (450) and reset (452). As with the first and second progressive threads and as described above, the nature of this payout event and the manner in which the third progressive award is assigned may vary greatly.

While the invention has been particularly shown and described with reference to specific embodiments thereof, it will be understood by those skilled in the art that changes in the form and details of the disclosed embodiments may be made without departing from the spirit or scope of the invention. For example, the progressive system described above with reference to FIG. 4 shows two progressives which are exclusively table game progressives and one which is associated with a combination of table games and gaming machines, and which has at least one subsidiary award associated therewith. It should be understood, however, that different combinations of these elements and various subsets thereof are within the scope of the invention. For example, a specific embodiment is contemplated corresponding to a progressive gaming system in which all of three or more progressives are exclusively table game progressives. Similarly, a progressive system with only one progressive game having a combination of table games and gaming machines associated therewith is within the scope of the invention. In addition, according to various embodiments of the invention, the subsidiary awards described above may be associated with any of the games in any such progressive systems.

In addition, progressive games designed according to the present invention may span multiple properties. For example, a prize hit on a Wheel of Fortune game in Ballys Las Vegas may trigger a random selection of a table and player location anywhere in the Ballys chain. This may occur by a notification to the pit boss from an operator monitoring the central system or may occur by generation of a promotional ticket specifying the award being generated within the pit which identifies the specific table and player position of the winner. Such ticket may be generated with great hoop-la to help further generate excitement. According to one embodiment, a large display shows a picture of the prize and when the player wins, the information regarding the winner is placed on the display in a celebration mode. The prize may also be a periodic increase in dollar value giving the appearance that the prize is incrementing due to game play, but in reality is incrementing based upon the time between prize awards.

According to some specific embodiments, the prizes are not randomly selected from a list of prizes. Rather, according to such embodiments, a single prize is defined for each defined progressive as part of the promotion until the prize is awarded. Once awarded, a new prize may be defined. However, since multiple progressives are possible, so are multiple prizes.

According to various specific embodiments involving “random” assignment of progressive prizes, the finding of the prizes comes from the marketing promotion itself rather than from side bets from participating players. In such embodiments, the casino may decide how many prizes and the types of prizes to be given away during the actual promotion. Thus, promotion funding would come from the operator and be accounted for as such. Other forms of funding may include prizes provided by system vendors. For example, a maintenance agreement between a casino operator and the system vendor might specify that a dollar amount per table per day is charged to the casino to fund both the maintenance of the system associated with the progressive(s) as well as at least some of the prizes associated with the progressive(s).

It should also be understood that the progressive gaming systems described herein may be associated with a single property or distributed among several properties as in the case, for example, where multiple casinos are participating in one or more progressives.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A progressive gaming system, comprising:
a plurality of table games having a plurality of progressive games associated therewith;
a plurality of network nodes, each network node being associated with one of the plurality of table games and being operable to transmit first information relating to game activity corresponding to the associated table game;
a network interconnecting the plurality of network nodes;
a server connected to the network for managing the plurality of progressive games, the server being operable to use the first information from the network nodes to control a plurality of awards associated with the plurality of progressive games, the server also being operable to assign at least one of the awards to a player at a corresponding one of the table games in response to a first corresponding event.

2. The progressive gaming system of claim 1 wherein the plurality of table games includes any type of table game which allows wagering.

3. The progressive gaming system of claim 1 wherein each network node comprises an interface by which at least a portion of the first information is received.

4. The progressive gaming system of claim 3 wherein the interface comprises at least one of a card reader, a key pad, and circuitry for automatically collecting the portion of the first information.

5. The progressive gaming system of claim 1 wherein the network comprises one of a local area network and a wide area network.

6. The progressive gaming system of claim 5 wherein the wide area network and the plurality of table games are associated with a plurality of gaming venues.

7. The progressive gaming system of claim 1 further comprising a plurality of gaming machines, each gaming machine being operable to transmit second information relating to game activity corresponding thereto.

8. The progressive gaming system of claim 7 wherein the plurality of gaming machines comprises any type of gaming machine which allows wagering.

9. The progressive gaming system of claim 7 wherein the server is further operable to use the second information to control at least some of the plurality of awards associated with the plurality of progressive games.

10. The progressive gaming system of claim 9 wherein the server is further operable to award at least one other of the awards associated with the plurality of progressive games to another player at a corresponding one of the gaming machines in response to a second corresponding event.

11. The progressive gaming system of claim 10 wherein the second corresponding event is unrelated to the game activity corresponding to the corresponding one of the gaming machines.

12. The progressive gaming system of claim 10 wherein the second corresponding event is related to the game activity corresponding to the corresponding one of the gaming machines.

13. The progressive gaming system of claim 10 wherein the second corresponding event corresponds to the game activity corresponding to one of the table games.

14. The progressive gaming system of claim 7 wherein the first corresponding event corresponds to the game activity corresponding to one of the gaming machines.

15. The progressive gaming system of claim 1 wherein the first corresponding event is unrelated to the game activity corresponding to the corresponding one of the table games.

16. The progressive gaming system of claim 1 wherein the first corresponding event is related to the game activity corresponding to the corresponding one of the table games.

17. The progressive gaming system of claim 1 wherein the first information further includes player tracking information.

18. The progressive gaming system of claim 17 wherein the player tracking information includes any of identification information, historical gaming behavior, and current gaming behavior.

19. The progressive gaming system of claim 1 wherein the server is operable to assign the at least one award where the player is participating in the corresponding table game.

20. The progressive gaming system of claim 1 wherein the server is operable to assign the at least one award only where the player is participating in the corresponding table game and affirmatively participating in a corresponding progressive game.

21. A computer-implemented method for managing a plurality of progressive games associated with a plurality of table games, each table game having a network node associated therewith for transmitting information relating to game activity corresponding to the associated table game, the network nodes being interconnected by a network, the method comprising:
receiving the information from the network nodes via the network;
using the information from the network nodes to control a plurality of awards associated with the plurality of progressive games; and
assigning at least one of the awards to a player at a corresponding one of the table games in response to a corresponding event.

22. A progressive gaming system, comprising:
a plurality of table games;
a plurality of network nodes, each network node being associated with one of the plurality of table games and being operable to transmit first information relating to game activity corresponding to the associated table game;
a plurality of gaming machines, each gaming machine being operable to transmit second information relating to game activity corresponding thereto;
a network interconnecting the plurality of network nodes and the plurality of gaming machines;
a server connected to the network for managing at least one progressive game associated with the plurality of table games and the plurality of gaming machines, the server being operable to use the first information from the network nodes and the second information from the gaming machines to control at least one award associated with the at least one progressive game, the server also being operable to assign the at least one award to a player at a corresponding one of the table games and the gaming machines in response to an event.

23. The progressive gaming system of claim 22 wherein the plurality of table games includes any type of table game which allows wagering, and the plurality of gaming machines comprises any type of gaming machine which allows wagering.

24. The progressive gaming system of claim 22 wherein each network node comprises an interface by which at least a portion of the first information is received.

25. The progressive gaming system of claim 24 wherein the interface comprises at least one of a card reader, a key pad, and circuitry for automatically collecting the portion of the first information.

26. The progressive gaming system of claim 22 wherein the network comprises one of a local area network and a wide area network.

27. The progressive gaming system of claim 26 wherein the wide area network and the plurality of table games are associated with a plurality of gaming venues.

28. The progressive gaming system of claim 22 wherein the event is unrelated to the game activity corresponding to the corresponding one of the table games and the gaming machines.

29. The progressive gaming system of claim 22 wherein the event is related to the game activity corresponding to the corresponding one of the table games and the gaming machines.

30. The progressive gaming system of claim 22 wherein the server is operable to assign the at least one award to a player at one of the gaming machines where the event corresponds to the game activity corresponding to one of the table games.

31. The progressive gaming system of claim 22 wherein the server is operable to assign the at least one award to a player at one of the table games where the event corresponds to the game activity corresponding to one of the gaming machines.

32. The progressive gaming system of claim 22 wherein the first and second information further includes player tracking information.

33. The progressive gaming system of claim 32 wherein the player tracking information includes any of identification information, historical gaming behavior, and current gaming behavior.

34. The progressive gaming system of claim 22 wherein the server is operable to assign the at least one award where the player is participating in the corresponding one of the table games and the gaming machines.

35. The progressive gaming system of claim 22 wherein the server is operable to assign the at least one award only where the player is participating in the corresponding one of the table games and the gaming machines and affirmatively participating in a corresponding progressive game.

36. A computer-implemented method for managing at least one progressive game associated with a plurality of table games and a plurality of gaming machines, each table game having a network node associated therewith for transmitting first information relating to game activity corresponding to the associated table game, each gaming machine being operable to transmit second information relating to game activity corresponding thereto, the network nodes and gaming machines being interconnected by a network, the method comprising:
receiving the first and second information from the network nodes and gaming machines via the network;
using the first and second information to control at least one award associated with the at least one progressive game; and
assigning the at least one award to a player at one of the table games and the gaming machines in response to an event.

37. A progressive gaming system, comprising:
a plurality of network gaming nodes having at least one progressive game associated therewith, each network node being operable to transmit information relating to associated game activity;
a network interconnecting the plurality of network gaming nodes;
a server connected to the network for managing the at least one progressive game, the server being operable to use the information from the network gaming nodes to control at least one award associated with the at least one progressive game, the server also being operable to assign the at least one award to a player associated with a first one of the network gaming nodes in response to an event unrelated to the game activity associated with the first one of the network gaming nodes.

38. The progressive gaming system of claim 37 wherein each of a subset of the network nodes is associated with one of a plurality of table games, the game activity associated with each of the subset of networks nodes corresponding to the associated table game.

39. The progressive gaming system of claim 37 wherein a subset of the network nodes comprises a plurality of gaming machines, the game activity associated with each of the subset of networks nodes corresponding to a corresponding one of the gaming machines.

40. The progressive gaming system of claim 37 wherein a first subset of the network nodes is associated with one of a plurality of table games, the game activity associated with each of the first subset of networks nodes corresponding to the associated table game, and wherein a second subset of the network nodes comprises a plurality of gaming machines, the game activity associated with each of the second subset of networks nodes corresponding to a corresponding one of the gaming machines.

41. The progressive gaming system of claim 40 wherein the at least one progressive game comprises a plurality of progressive games and the at least one award comprises a plurality of awards corresponding to the plurality of progressive games.

42. The progressive gaming system of claim 41 wherein at least one of the plurality of progressive games corresponds only to selected ones of the plurality of table games.

43. The progressive gaming system of claim 41 wherein at least one of the plurality of progressive games corresponds only to selected ones of the plurality of gaming machines.

44. The progressive gaming system of claim 41 wherein at least one of the plurality of progressive games corresponds to selected ones of the table games and gaming machines.

45. The progressive gaming system of claim 37 wherein the server is operable to assign the at least one award to the player where the event corresponds to the game activity associated with a second one of the network nodes.

46. The progressive game of claim 45 wherein the event comprises winning of another progressive associated with the second one of the network nodes.

47. The progressive gaming system of claim 37 wherein the information further includes player tracking information, and wherein the event corresponds to identification of a specific piece of information in the player tracking information associated with the player.

48. The progressive gaming system of claim 47 wherein the specific piece of information comprises a correlation between an anniversary date associated with the player and a current date.

49. The progressive gaming system of claim 37 wherein the event comprises expiration of a period of time.

50. A computer-implemented method for managing at least one progressive game associated with a plurality of network gaming nodes, each network node being operable to transmit information relating to associated game activity, the network nodes being interconnected by a network, the method comprising:
receiving the information from the network nodes via the network;
using the information to control at least one award associated with the at least one progressive game; and
assigning the at least one award to a player associated with a first one of the network gaming nodes in response to an event unrelated to the game activity associated with the first one of the network gaming nodes.
